(19) United States
(12) Patent Application Publication
(10) Pub. No.: US 2026/0310702 A1
(43) Pub. Date: Oct. 8, 2026

(54) NATIVE RETRIEVAL AUGMENTED GENERATION MODEL(S)

(71) Applicant: GOOGLE LLC, Mountain View, CA (US)

(72) Inventors: Zhe Dong, Zurich (CH); Fedor Moiseev, Zurich (CH); Henrique Schechter Vera, New York, NY (US); Sahil Dua, Zurich (CH); Paul Suganthan G C, Zurich (CH)

(21) Appl. No.: 19/570,852

(22) Filed: Mar. 18, 2026

Related U.S. Application Data
(60) Provisional application No. 63/783,572, filed on Apr. 4, 2025.

(51) Int. Cl. G06F 16/334; G06F 16/3329

(52) U.S. Cl. CPC G06F 16/3344; G06F 16/3329

(57) ABSTRACT

Various implementations include a method for processing a natural language user query using a native retrieval augmented generation (NatRAG) model. The method includes receiving a natural language (NL) user query and processing it using a NatRAG model comprising a generative portion with decoder layers and a retrieval portion. Processing involves generating NatRAG input, processing it with the generative portion to produce output tokens, and determining if a “need to retrieve” (N-t-R) token is present. If so, the retrieval portion processes decoder layers to generate retrieval tokens, which are appended to the input to create updated NatRAG input. This updated input is then processed by the NatRAG model to generate output, enabling the device to perform actions based on the generated output.

### BACKGROUND

Retrieval augmented generation (RAG) is a technique where a generative model (e.g., a large language model) retrieves relevant information from an external knowledge base before generating a response. The external knowledge base can augment the knowledge of the generative model beyond the knowledge captured in the generative model training data (e.g., the external knowledge base can augment the generative model with current news articles).

However, RAG typically relies on separate, independently trained models for generation and retrieval (e.g., a first model trained for generation and a separate second model trained for retrieval). Such a configuration, while effective for retrieval-augmented generation, may result in significant latency due to the independent operation of each model.

### SUMMARY

Implementations described herein provide for native retrieval augmented generation (NatRAG) models which combine a generative model and a retrieval model into a single NatRAG model. In contrast, RAG models typically require separate and/or independent retrieval and generation models. By integrating the retrieval and generation functionalities into a single NatRAG model, implementations described herein reduce latency (e.g., the time between a user providing a query and the system providing a response to the query) due to the improved computational efficiency of sharing operations across both retrieval and generation. In addition to improving computational efficiency, the techniques described herein may reduce model size by combining the retrieval model and the generation model into a single NatRAG model.

In some implementations, the generative portion of the NatRAG model is based on a pre-trained generative model (e.g., a decoder-only model). For example, the generative portion of the NatRAG model may be generated based on setting frozen weights, of a set of attention layers of the generative model portion of the NatRAG model, based on weights of a set of attention layers of the pre-trained generative model (e.g., a decoder-only model).

Additionally or alternatively, the retrieval portion of the NatRAG model may include one or more trainable layer weights, wherein the one or more trainable layer weights are learnable parameters indicating the strength of connection between the set of attention layers of the generative model portion of the NatRAG model.

In some implementations, the NatRAG model can determine when the system needs to retrieve additional information to continue generating the responsive output. In some versions of those implementations, the system can generate a token indicating the NatRAG model needs more information. For example, the model can generate a need to retrieve (N-t-R) token. The N-t-R token is an indication the model needs more information. In response to determining the generative portion generated the N-t-R token, the system can process one or more layers (e.g., one or more decoder layers) of the generative model portion of the NatRAG model using one or more trainable layer weights of the retrieval model portion of the NatRAG model. In other words, the system can share information directly between the generative and retrieval portions of the NatRAG model. The retrieval portion of the NatRAG model can generate a sequence of retrieval tokens based on the one or more documents identified by the retrieval portion as being relevant. The system can then append the sequence of retrieval tokens to prefix and/or decoded tokens for input into the generative portion of the NatRAG model.

In contrast, existing RAG models typically require generating a retrieval prompt including the information requested; transmitting the retrieval prompt to the retrieval model; processing the retrieval prompt using the retrieval model to generate the requested information; transmitting the requested information to the generative model; generating an updated prompt including at least the original prompt and the requested information; and processing the updated prompt using the generative model to generate responsive output.

For example, a user can provide a query of “Where can I get tacos for dinner tomorrow night?” The system can process the user query using the NatRAG model to generate responsive output of “Hypothetical Cafe is a great spot for tacos on Tuesday nights.” In some implementations, the generative portion can generate output indicating a request for more information (e.g., a N-t-R token).

In response to determining the model generated the N-t-R token while generating output responsive to the user query of “Where can I get tacos for dinner tomorrow night?”, the system can process one or more portions of the generative portion of the NatRAG model using the one or more trainable layer weights of the retrieval portion of the NatRAG model. In other words, the model can begin retrieving additional information without generating a new prompt for the retrieval portion of the NatRAG model and/or without transmitting data to an external model. In contrast, existing RAG techniques generally require generating and transmitting a new prompt requesting information to the retrieval model.

Additionally or alternatively, the retrieval portion of the NatRAG model can generate output indicating one or more documents (e.g., indexed documents) related to the user query. In some of those implementations, the retrieval portion of the NatRAG model includes an embedding representation of the one or more identified documents (e.g., a sequence of tokens in the retrieved document(s). For instance, the output of the retrieval portion of the NatRAG model can include a sequence of tokens representing information based on local restaurants that serve tacos on Tuesday night (e.g., location, menu, reviews, etc.).

The sequence of tokens generated using the retrieval portion of the NatRAG model can be appended to and/or otherwise combined with the prefix and/or decoded tokens provided as input to the generative portion of NatRAG model. In some implementations, the NatRAG model can cache the prefix and/or previously decoded tokens such that the tokens in the retrieved document can simply be appended to the cached tokens, and do not need to be re-generated. In other words, the system does not need to transmit the retrieval output to an external model and/or the system does not need to reencode previously decoded output.

The above description is provided as an overview of only some implementations disclosed herein. These and other implementations are described in more detail herein, including in the detailed description and the claims.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 illustrates an example architecture of a NatRAG model in accordance with various implementations described herein.

FIG. 2A illustrates an example of a NatRAG model generating a sequence of output tokens including a need to retrieve (N-t-R) token, in accordance with various implementations described herein.

FIG. 2B illustrates an example of appending retrieval tokens to NatRAG input in accordance with various implementations described herein.

FIG. 3 depicts a flowchart illustrating an example process for generating NatRAG output responsive to a NL user query, in accordance with various implementations described herein.

FIG. 4 depicts a flowchart illustrating an example process for processing the updated NatRAG input to generate NatRAG output, in accordance with various implementations described herein.

FIG. 5 illustrates an example environment in which various implementations disclosed herein may be implemented.

FIG. 6 illustrates an example architecture of a computing device.

### DETAILED DESCRIPTION

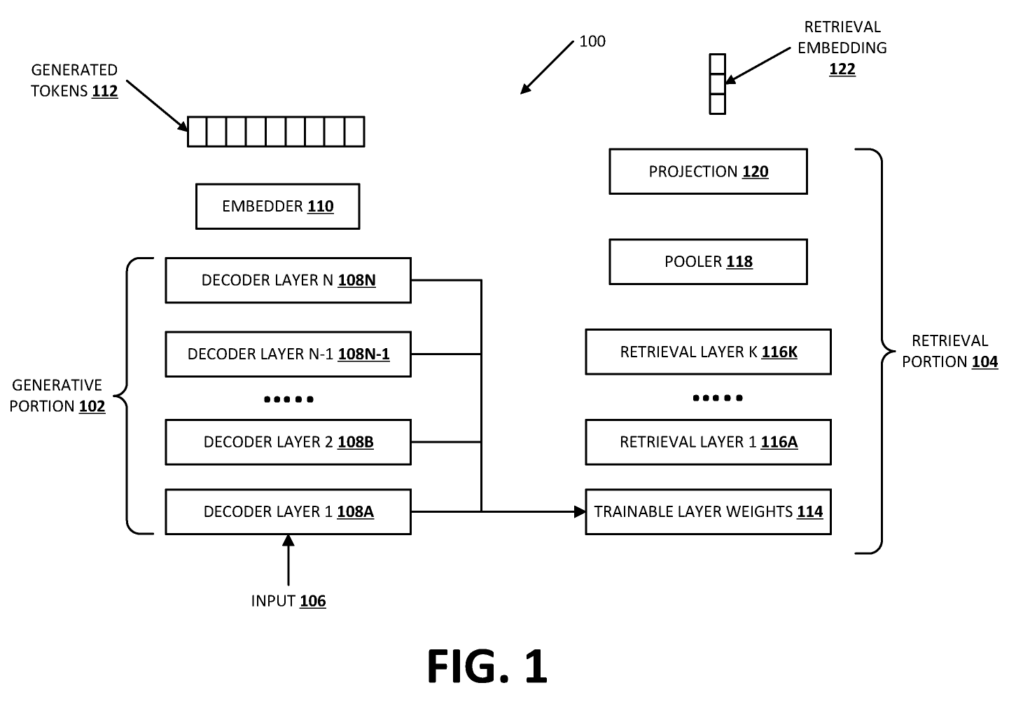

Turning now to the figures, FIG. 1 illustrates an example architecture of a NatRAG model 100. The NatRAG model 100 can include a generative portion 102 and a retrieval portion model 104. In some implementations, the generative portion 102 of the NatRAG model 100 can be based on a pre-trained generative model (e.g., a pre-trained decoder-only model). For example, the generative portion 102 of the NatRAG model 100 may be generated based on setting frozen weights, of a set of attention layers of the generative model portion of the NatRAG model 100, based on weights of a set of attention layers of the pre-trained generative model (e.g. , a decoder-only model).

In some implementations, the generative portion 102 can process input 106. In some implementations, the input 106 can be an encoded representation of a natural language (NL) user query. For example, the input 106 can be an embedding vector, generated based on processing the NL user query using an embedding model. Input 106 can be processed using a set of decoder layers 108A-108N of the generative portion 102. In some implementations, the set of decoder layers 108A-108N can be based on a pre-trained decoder-only model. For example, each decoder layer 108 can include a corresponding set of activation weights which can be initialized based on a corresponding set of weights of corresponding decoder layers in the pre-trained decoder-only model. In some implementations, the set of decoder layers 108A-108N can process the input 106 and to generate decoder output, where the decoder output is processed using embedder 110 to generate a sequence of output tokens 112.

In some implementations, the generative portion 102 of the NatRAG model can generate a token indicating new information is needed by the generative portion, such as a needs to retrieve (N-t-R) token. The N-t-R token indicates the generative portion of the NatRAG model needs more information to generate a response to the NL user query. For example, the generative portion 102 of the NatRAG model can require additional context and can request relevant documents for the additional context using the retrieval portion 104 of the NatRAG model. Traditional RAG techniques typically require generating a retrieval prompt indicating the additional context. In contrast, the N- t-R token is a request for additional context without requiring a dedicated retrieval prompt for the additional context.

When the system determines the generative portion 102 of the NatRAG model 100 has generated an N-t-R token, one or more portions of the set of decoder layers 108 of the generative portion 102 can be processed using one or more trainable layer weights 114 of the retrieval portion 104 of the NatRAG model 100. The generative portion 102 of the NatRAG model 100 can be based on a pre-trained generative model (e.g., a pre-trained decoder-only model). For example, each decoder layer 108 can include a set of attention weights which can be initialized based on a corresponding set of attention weights of a corresponding decoder layer in the pre-trained decoder only model. To preserve the semantic knowledge of the pre-trained decoder-only model, the attention weights of the decoder layers 108 can be frozen. While the attention weights of the decoder layers 108 are frozen, the NatRAG model can be trained by training one or more trainable layer weights 114. For example, each decoder layer 108A, 108B, … , 108N can have a corresponding trainable layer weight 114, where the trainable layer weights can 114 can be used to combine the per-layer activations of each decoder layer. In some implementations, the last decoder layers may be task-specific. In some versions of those implementations, the activation weights of the inner layers of the generative portion 102 can be weighed more heavily than the activation weights of the last decoder layers.

In some implementations, a set of retrieval layers 116A-116K of the retrieval portion 104 can process the output of the trainable layer weights 114. In other words, the retrieval layers 116 can process the activations of the decoder layers of the generative portion 102 after the layer weights have been reweighed. Additionally or alternatively, one or more pooling layers 118 can process output generated by the set of retrieval layers 116. A variety of pooling layers can be integrated into the NatRAG model 100 including mean pooling, attention pooling, last token pooling, max pooling, and/or additional or alternative pooling techniques. In some implementations, mean pooling can include averaging the hidden states across each of the tokens in the sequence. Additionally or alternatively, attention pooling can use an attention mechanism to weight and aggregate token representations. Furthermore, last token pooling can use the hidden state of the final token in the sequence.

In some implementations, a projection layer 120 (which can be a mean layer and/or another projection layer) can process output generated by the set of retrieval layers 116 and/or pooler 118. In some implementations, the projection layer 120 can generate an embedding representation of the documents identified by the retrieval portion 104. For example, the projection layer 120 can generate an encoding based on the input generated by the pooler 118. The encoding generated by the projection layer 120 can be used to retrieve one or more documents, such as one or more indexed documents from a knowledge base.

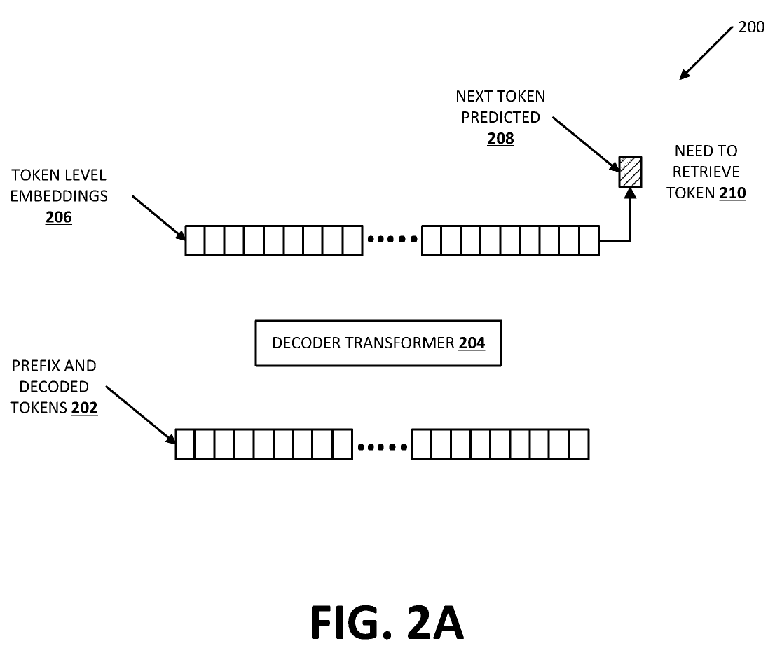

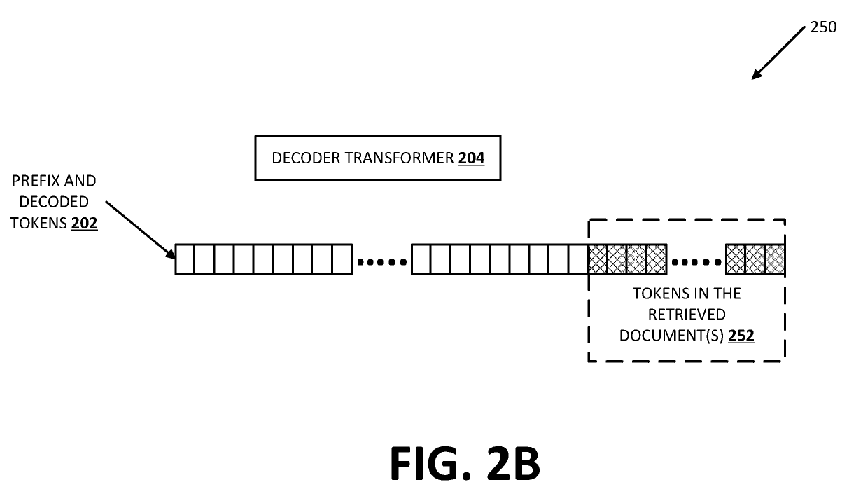

FIG. 2A illustrates an example of a NatRAG model 200 generating a sequence of output tokens including a need to retrieve (N-t-R) token 210, in accordance with various implementations described herein. NatRAG model 200 includes a sequence of prefix and decoded tokens 202 which are provided as input to the generative portion of the NatRAG model 200. As an illustrative example, the generative portion of the NatRAG model is illustrated as decoder transformer 204 in FIG. 2A. However, this is not meant to be limiting, and the generative portion of the NatRAG model can be based on one or more additional and/or alternative models, such as a sequence-to-sequence network, a transformer network, and/or one or more additional and/or alternative models.

In some implementations, the generative portion of the NatRAG model 200 generates output including a sequence of token level embeddings 206. In the illustrated example, the sequence of token level embeddings includes an indication of a next token predicted 208, where the next token predicted is a N-t-R token 210. In other words, the generative portion of the NatRAG model 200 generates output tokens until the output sequence is completed or until a N-t-R token indicating more information is needed is generated. In some implementations, the generative portion of the NatRAG model 200 stops generating additional tokens when the system determines a N-t-R token has been generated until one or more retrieved tokens are identified by the retrieval portion.

FIG. 2B illustrates an example 250 of appending retrieval tokens to NatRAG input in accordance with various implementations described herein. In the illustrated example 250, the retrieval portion of the NatRAG model has generated retrieval output tokens 252 (where generating the retrieval output tokens 252 is not depicted in FIG. 2B). In some implementations, the tokens in the retrieved document(s) 252 are contextually relevant information for the NL user query provided as input to the generative portion of the NatRAG model. Additionally or alternatively, the tokens in the retrieved document(s) 252 are generated by the retrieval portion of the NatRAG model in response to the generative portion of the NatRAG model generating an N-t-R token. In some implementations, the retrieved tokens 252 are appended to the end of the prefix and any previously decoded tokens 202 to generate updated NatRAG input for further processing by the generative portion of the NatRAG model. In some versions of those implementations, the prefix and decoded token(s) 202 are cached in memory of a computing device implementing the NatRAG model. Unlike traditional RAG techniques, the NatRAG model does not need to regenerate the prefix or already decoded tokens each time the retrieved tokens 252 are appended to the prefix and any previously decoded token(s) 202.

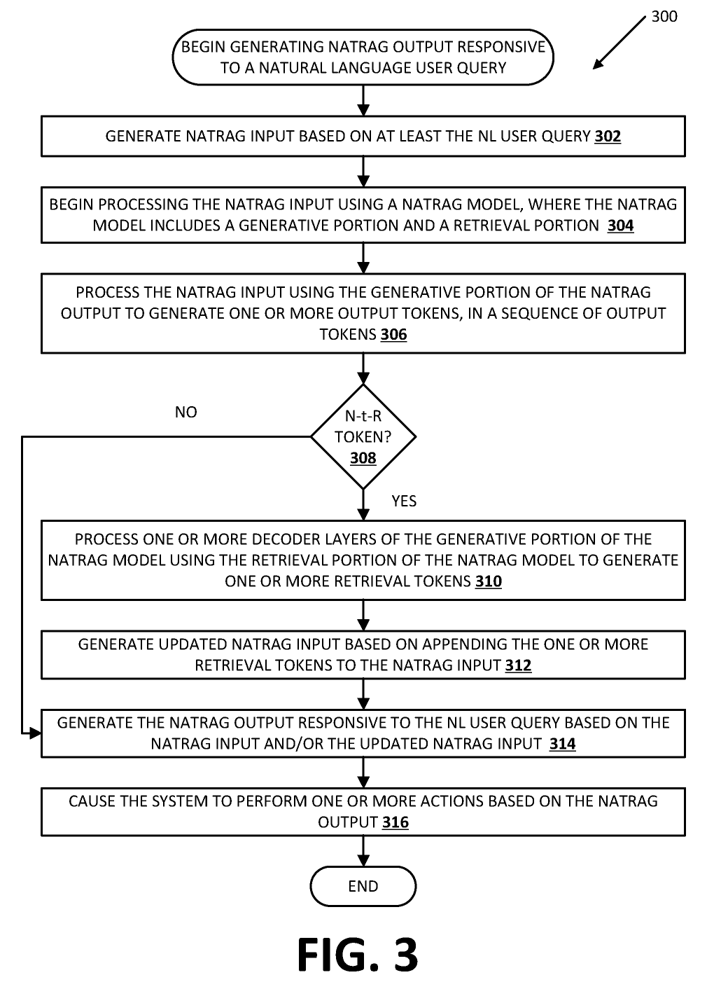

FIG. 3 depicts a flowchart illustrating an example process 300 for generating NatRAG output responsive to a NL user query, in accordance with various implementations. For convenience, the operations of process 300 are described with reference to a system that performs the operations. This system may include various components of various computer systems, such as one or more components of computing device 502 and/or computing system 510. Moreover, while operations of process 300 are shown in a particular order, this is not meant to be limiting. One or more operations may be reordered, omitted, and/or added.

The system begins generating NatRAG output responsive to a NL user query. In some implementations, the NatRAG model includes a generative portion and a retrieval portion in accordance with various implementations described herein.

At block 302, the system generates NatRAG input based on at least the user query. As one non-limiting example, the system can process the NL user query using an embedding model to generate input. For instance, the input may be an embedding vector generated based on processing the NL user query using the embedding model. Additionally or alternatively, the NatRAG input can be updated NatRAG based on a prefix and previously decoded tokens, and one or more additional retrieval tokens generated using the retrieval portion of the NatRAG model, where the one or more additional retrieval tokens are appended to the NatRAG input.

At block 304, the system begins processing the NatRAG input using the NatRAG model, where the NatRAG model includes a generative portion and a retrieval portion. In some implementations, the NatRAG model has a generative portion 102 and a retrieval portion 104 in accordance with NatRAG model 100 described herein with respect to FIG. 1.

At block 306, the system processes the NatRAG input using the generative portion of the NatRAG model to generate one or more output tokens and/or predicted next token(s). In some implementations, the sequence of output tokens can include a token indicating the generative portion of the NatRAG model needs more information, such as an N-t-R token. Traditional RAG techniques typically include generating a new prompt requesting specific additional context. In contrast, the NatRAG model indicates the generative portion needs additional context, but does not specify the information the generative portion needs.

At block 308, the system determines whether the one or more output tokens and/or predicted next token(s) includes the N-t-R token. If the system determines an output token and/or predicted next token(s) includes a N-t-R token, then the process 300 proceeds to block 310. If the system determines an output token and/or predicted next token(s) does not include a N-t-R token, then the process 300 proceeds to block 314.

At block 310, the system processes one or more portions of the generative portion of the NatRAG model using one or more trainable layer weights of the retrieval portion of the NatRAG model to generate one or more retrieval tokens. For example, each decoder layer of the generative portion of the NatRAG model can have a corresponding set of activation weights, and the one or more trainable layer weights can be used to combine the activation weights of the decoder layer. The set of activation weights, for each decoder layer of the generative portion of the NatRAG model, is updated while the generative portion is processing the NatRAG input. The trainable layer weights of the retrieval portion of the NatRAG model are learned parameters indicating the strength of connection between the set of decoder layers of the generative portion of the NatRAG model.

Output generated using the layer weights can be processed using one or more retrieval layers of the retrieval portion of the NatRAG model. In some implementations, the retrieval layer output can indicate one or more documents (e.g., an entry in an index indicating a document) contextually related to information contained in the decoder layers of the generative portion. Additionally or alternatively, output generated by the retrieval layers can be processed using one or more pooling layers, such as a max pooling layer, an attention pooling layer, and/or one or more additional pooling techniques. In some implementations, output generated by the pooling layer can be processed using a projection layer (e.g., an average pooling layer). In some implementations, the projection layer can generate an output embedding representation of the retrieved document(s) contextually relevant to the information in the decoder layers of the generative portion of the NatRAG model. For example, the output of the retrieval portion of the NatRAG model can include an embedding representation of the contextually relevant information.

At block 312, the system appends the retrieval token(s) generated using the retrieval portion of the NatRAG model to the NatRAG input to generate updated NatRAG input. In some implementations, the system can append the retrieval token(s) to the prefix and any previously decoded tokens included in the sequence of the NatRAG input to generate an updated NatRAG input. In some versions of those implementations, the prefix and decoded token(s) are cached in memory of a computing device implementing the NatRAG model, and the retrieval token(s) are stored as part of the updated NATRAG input. In other words, the system does not re-compute or regenerate the prefix and/or the decoded token(s) when incorporating the retrieval token(s) as part of the updated NatRAG input.

At block 314, the system generates NatRAG output responsive to the NL user query based on processing the updated NatRAG input. For example, the system can process the updated NatRAG input using the one or more decoder layers of the generative portion to generate updated decoder output. In some implementations, the decoder output can be processed, using an embedding model, to generate additional output tokens, in the sequence of output tokens.

At block 316, the system causes the computing device to perform one or more actions based on the NatRAG output. For example, the system can cause the computing device to render a response to the NL user query based on the NatRAG output. Additionally or alternatively, the system can cause the computing device to perform one or more actions based on the NatRAG output. For example, the system can cause the computing device to perform an action in addition to or in lieu of generating a response to the NL user query based on the NatRAG output.

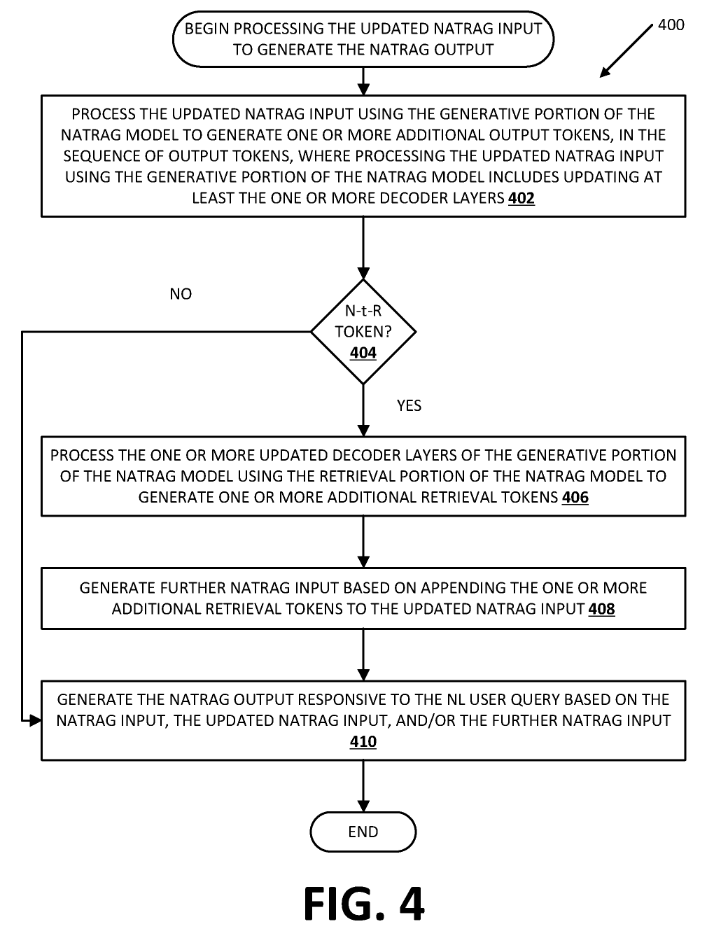

FIG. 4 depicts a flowchart illustrating an example process 400 for processing the updated NatRAG input to generate NatRAG output, in accordance with various implementations. For convenience, the operations of process 400 are described with reference to a system that performs the operations. This system may include various components of various computer systems, such as one or more components of computing device 502 and/or computing system 510. Moreover, while operations of process 400 are shown in a particular order, this is not meant to be limiting. One or more operations may be reordered, omitted, and/or added.

At block 402, the system processes the updated NatRAG input using the generative portion of the NatRAG model to generate one or more additional output tokens, in the sequence of output tokens. In some implementations, processing the updated NatRAG input using the generative portion of the NatRAG model includes updating at least the decoder layers (e.g., updating one or more activation weights corresponding to the decoder layers) based on the updated NatRAG input. The system can generate additional decoder output based on processing the updated NatRAG input. Additionally or alternatively, the updated decoder output can be processed, using an embedding model, to generate additional output tokens and/or predicted next output token(s), in the sequence of output tokens. In some implementations, the additional output tokens can include an additional N-t-R token, indicating the generative portion of the NatRAG model requires further information.

At block 404, the system determines whether the one or more additional output tokens and/or predicted next output token(s) includes an additional instance of the N-t-R token. If the system determines an output token and/or predicted next output token(s) includes an additional instance of the N-t-R token, the system proceeds to block 406. If the system determines an output token and/or predicted next output token(s) do not include an additional instance of the N-t-R token, then the system proceeds to block 410.

At block 406, the system processes one or more portions of the updated decoder layers of the generative portion of the NatRAG model using the one or more trainable layer weights of the retrieval portion of the NatRAG model to generate one or more additional retrieval tokens. The trainable layer weights of the retrieval portion of the NatRAG model are learnable parameters indicating the strength of connection between the set of decoder layers of the generative portion of the NatRAG model. In some implementations, the additional output using the layer weights can be processed using the one or more retrieval layers of the retrieval portion of the NatRAG model. In some implementations, the additional retrieval layer output can indicate one or more additional documents (e.g., an entry in an index indicating an additional document) contextually related to information contained in the decoder layers of the generative portion. Additionally or alternatively, the additional output generated by the retrieval layers can be processed using the one or more pooling layers of the retrieval portion (such as a max pooling layer, an attention pooling layer, and/or one or more additional pooling techniques). In some implementations, additional output generated using the pooling layers can be processed using the projection layer to generate the additional retrieval token(s).

At block 408, the system appends the additional retrieval token(s) to the updated NatRAG input to generate further NatRAG input. In some implementations, the additional retrieval token(s) are appended to the prefix and any previously decoded tokens included in the updated NatRAG input to generate further NatRAG input.

At block 410, the system processes the further NatRAG input using the generative portion of the NatRAG model to generate the NatRAG output responsive to the NL user query based on the NatRAG input, the updated NatRAG input, and/or the further NatRAG input.

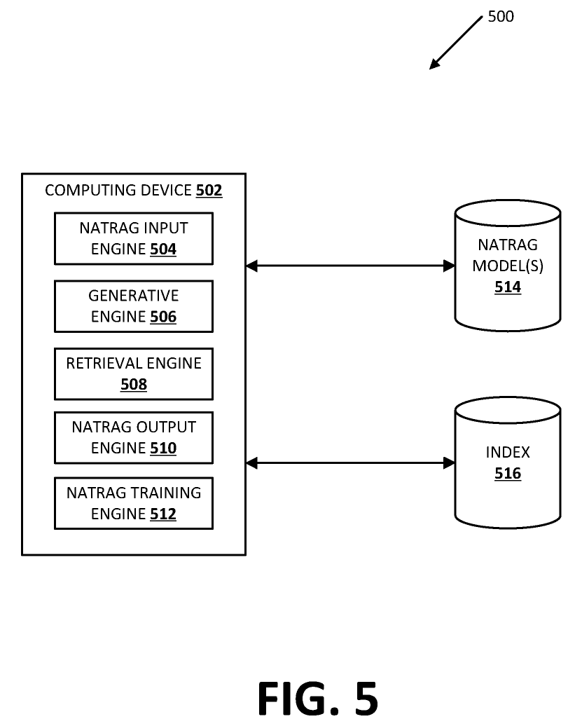

FIG. 5 is a block diagram of an example environment 500 in which various implementations disclosed herein may be implemented. The example environment 500 includes a computing device 502, one or more user interface input/output devices (not depicted), one or more additional or alternative components (not depicted), and/or combinations thereof. The computing device 502 includes a NatRAG input engine 504, a generative engine 506, a retrieval engine 508, a NatRAG output engine 510, a NatRAG training engine 512, one or more additional or alternative engines (not depicted), and/or combinations thereof. Additionally or alternatively the computing device 502 may be associated with NatRAG model 514, index 516, one or more additional or alternative components (not depicted), and/or combinations thereof.

In some implementations, the computing device 502 and/or additional or alternative components may be communicatively coupled with each other via one or more networks, such as one or more wired or wireless local area networks (" LANs" including Wi-Fi LANs, mesh networks, Bluetooth, near-field communication, etc.) or wide area networks (“WANs” including the Internet).

In some implementations, the computing device 502 may include one or more user interface input/output devices (not depicted), which may include, for example, a physical keyboard, a touch screen (e.g., implementing a virtual keyboard or other textual input mechanisms), a microphone, a camera, a display screen, and/or speaker(s). The user interface input/output devices may be incorporated with one or more computing devices 502 of a user. For example, a mobile phone of the user may include the user interface input/output device(s), a standalone digital assistant device may include the user interface input/output device(s), a first computing device may include the user interface input device(s) and a separate computing device may include the user interface output device(s), etc.

Some non-limiting examples of computing device 502 include one or more of: a desktop computing device, a laptop computing device, a standalone hardware device at least in part dedicated to an automated assistant, a tablet computing device, a mobile phone computing device, a computing device of a vehicle (e.g., an in-vehicle communications system, and in-vehicle entertainment system, an in-vehicle navigation system, etc.), or a wearable apparatus of the user that includes a computing device (e.g., a watch of the user having a computing device, glasses of the user having a computing device, a virtual or augmented reality computing device, etc.). Additional and/or alternative computing devices may be provided. Computing device 502 may include one or more memories for storage of data and software applications, one or more processors for accessing data and executing applications, and other components that facilitate communication over a network. The operations performed by computing device 502 may be distributed across multiple computer systems. For example, computing programs running on one or more computers in one or more locations can be coupled to each other through a network.

In some implementations, the NatRAG model 514 can process input based on a NL user query to generate responsive output. For example, NatRAG model 514 can include a generative and a retrieval portion integrated into a single model (e.g., a generative portion and a retrieval portion of the NatRAG model) such as NatRAG model 100 described herein with respect to FIG. 1. Additionally or alternatively, index 516 can index one or more documents (e.g., text documents, HTML documents, emails, spreadsheets, presentations, audio files, video files, knowledge graphs, structured data, etc.).

NatRAG input engine 504 can process NL user input, such as a NL user query received via one or more user interface input devices (e.g., a physical keyboard, a touch screen (e.g., implementing a virtual keyboard or other textual input mechanisms), a microphone, one or more additional or alternative user interface input devices, and/or combinations thereof). For example, a user can provide a NL user query using a keyboard. NatRAG input engine 504 can process the NL user query to generate input for the generative portion of the NatRAG model 514. Additionally or alternatively, NatRAG input engine 504 can generate data representing the NL user query, such as an embedding vector generated based on processing the NL user query using an embedding model. In some implementations, NatRAG input engine 504 can provide the input to generative engine 506. In some implementations, generative engine 506 can cause NatRAG model 514 to process the NatRAG input (e.g., generated using NatRAG input engine 504) using the generative portion of the NatRAG model to generate one or more output tokens. In some implementations, generative engine 506 can determine whether one or more of the generated output tokens and/or predicted output tokens include a N-t-R token.

In some implementations, retrieval engine 508 can cause the retrieval portion of the NatRAG model 514 to process one or more portions of the generative portion, such as one or more activation weights of decoder layers in the generative portion, using one or more trainable layer weights of the retrieval portion to generate retrieval input. Additionally or alternatively, the retrieval engine 508 can cause one or more retrieval layers of the retrieval portion to process the retrieval input to generate retrieval output. In some implementations, retrieval engine 508 can process retrieval output using a set of pooling layers and/or a set of projection layers to generate retrieval embeddings, where the retrieval embeddings can indicate one or more documents (e.g., an entry in the index 516) contextually relevant to the information in the decoder of the generative portion.

NatRAG input engine 504 can append the retrieval embeddings to an existing instance of NatRAG input to generate updated NatRAG input. For example, the NatRAG input can include a prefix and/or one or more previously decoded tokens, where NatRAG input engine 504 appends tokens retrieved using the retrieval portion of the NatRAG model 514 to the end of the prefix and/or the one or more previously decoded tokens.

Furthermore, NatRAG output engine 510 can process the sequence of output tokens generated using the generative portion of the NatRAG model 514 to generate output responsive to the NL user query. In some implementations, NatRAG output engine 510 can cause the computing device 502 to perform one or more actions based on the output responsive to the user query.

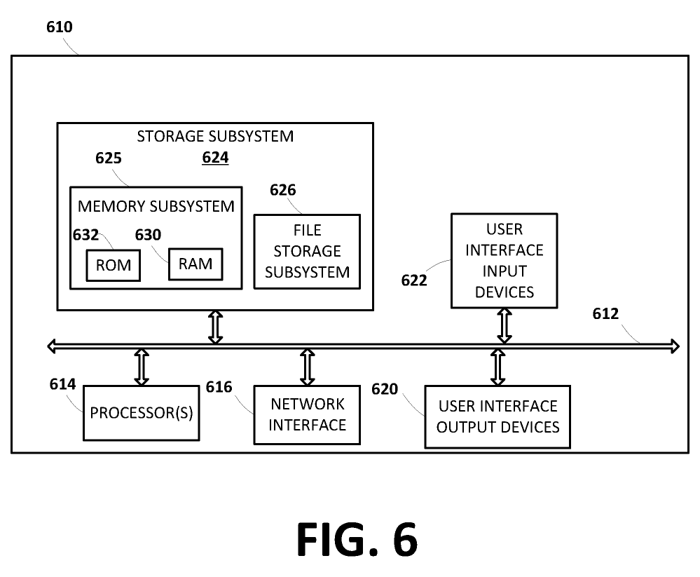

Turning now to FIG. 6, a block diagram of an example computing device 610 that may optionally be utilized to perform one or more aspects of techniques described herein and/or implement one or more aspects described herein is depicted. In some implementations, one or more of a client device, a cloud-based automated assistant component(s), and/or other component(s) may comprise one or more components of the example computing device 610. It will be appreciated that one or more components of the example computing device 610 may be provided by one or more other devices described herein.

Computing device 610 typically includes at least one processor 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computing device 610. Network interface subsystem 616 provides an interface to outside networks and is coupled to corresponding interface devices in other computing devices.

User interface input devices 622 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computing device 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 610 to the user or to another machine or computing device.

Storage subsystem 624 stores programming and data constructs that provide the functionality of some or all of the modules described herein. For example, the storage subsystem 624 may include the logic to perform selected aspects of one or more of the processes of FIGS. 3 and/or 4 , as well as to implement various components depicted therein and/or described herein.

These software modules are generally executed by processor 614 alone or in combination with other processors. Memory 625 used in the storage subsystem 624 can include a number of memories including a main random access memory (RAM) 630 for storage of instructions and data during program execution and a read only memory (ROM) 632 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 626 in the storage subsystem 624, or in other machines accessible by the processor(s) 614.

Bus subsystem 612 provides a mechanism for letting the various components and subsystems of computing device 610 communicate with each other as intended. Although bus subsystem 612 is shown schematically as a single bus, alternative implementations of the bus subsystem may use multiple buses.

Computing device 610 can be of varying types including a workstation, server, computing cluster, blade server, server farm, or any other data processing system or computing device. Due to the ever-changing nature of computers and networks, the description of computing device 610 depicted in FIG. 6 is intended only as a specific example for purposes of illustrating some implementations. Many other configurations of computing device 610 are possible having more or fewer components than the computing device depicted in FIG. 6.

In situations in which the systems described herein collect or otherwise monitor personal information about users, or may make use of personal and/or monitored information), the users may be provided with an opportunity to control whether programs or features collect user information (e.g., information about a user’s social network, social actions or activities, profession, a user’s preferences, or a user’s current geographic location), or to control whether and/or how to receive content from the content server that may be more relevant to the user. Also, certain data may be treated in one or more ways before it is stored or used, so that personal identifiable information is removed. For example, a user’s identity may be treated so that no personal identifiable information can be determined for the user, or a user’s geographic location may be generalized where geographic location information is obtained (such as to a city, ZIP code, or state level), so that a particular geographic location of a user cannot be determined. Thus, the user may have control over how information is collected about the user and/or used.

In some implementations, a method implemented by one or more processors is provided and includes receiving a natural language user query at a computing device. The method includes processing the natural language user query using a native retrieval augmented generation model to generate native retrieval augmented generation output responsive to the natural language user query. The native retrieval augmented generation model includes a generative portion and a retrieval portion. Processing the natural language user query using the native retrieval augmented generation model to generate native retrieval augmented generation output includes generating native retrieval augmented generation input based on at least the natural language user query. The method includes processing the native retrieval augmented generation input using the generative portion of the native retrieval augmented generation model to generate one or more output tokens, in a sequence of output tokens. The generative portion of the native retrieval augmented generation model includes at least a set of decoder layers. The method includes determining whether the one or more output tokens includes a need to retrieve token. The need to retrieve token indicates the generative portion of the native retrieval augmented generation model requires additional information. One or more portions of the set of decoder layers are processed using the retrieval portion of the native retrieval augmented generation model to generate one or more retrieval tokens in a sequence of retrieval tokens. The method includes appending the one or more retrieval tokens to the native retrieval augmented generation input to generate updated native retrieval augmented generation input. The updated native retrieval augmented generation input is processed using the native retrieval augmented generation model to generate native retrieval augmented generation output responsive to the natural language user query. The method includes causing the computing device to perform one or more actions based on the native retrieval augmented generation output.

These and other implementations of technology disclosed herein may optionally include one or more of the following features.

In some implementations, processing the updated NatRAG input using the NatRAG model to generate NatRAG output responsive to the NL user query can include processing the updated NatRAG input using the generative portion of the NatRAG model to generate one or more additional output tokens, in the sequence of output tokens, where processing the updated NatRAG input using the generative portion of the NatRAG model can include updating at least the set of decoder layers based on the updated NatRAG input. In some of those implementations, determining whether the one or more additional output tokens can include an additional instance of the N-t-R token. In some versions of those implementations, processing one or more portions of the updated set of decoder layers using the retrieval portion of the NatRAG model can generate one or more additional retrieval tokens in an additional sequence of retrieval tokens. In some versions of those implementations, appending the one or more additional retrieval tokens to the updated NatRAG input can generate further NatRAG input. In some versions of those implementations, processing the further NatRAG input using the NatRAG model can generate NatRAG output responsive to the NL user query.

In some implementations, the generative portion of the NatRAG model can be a pre-trained decoder only model.

In some of those implementations, the generative portion of the NatRAG model can be generated based on setting frozen weights, of a set of attention layers corresponding to the set of decoder layers, based on weights of a set of attention layers of the pre-trained decoder only model.

In some versions of those implementations, the retrieval portion of the NatRAG model can include one or more trainable layer weights, where the one or more trainable layer weights can be learnable parameters indicating the strength of connection between the set of attention layers of the generative portion of the NatRAG model.

In some implementations, appending the one or more retrieval tokens to the NatRAG input to generate the updated NatRAG input cannot include reencoding previously encoded output.

In some implementations, the updated NatRAG input can be generated based on appending the one or more retrieval tokens to an instance of the NatRAG input stored in memory of the computing device.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the methods described herein. Some implementations also include one or more computer readable storage media (e.g., transitory or non-transitory) storing computer instructions executable by one or more processors to perform any of the methods described herein. Some implementations also include a computer program product including instructions executable by one or more processors to perform any of the methods described herein.

What is claimed is:

1. A method implemented by one or more processors, the method comprising:
receiving a natural language (NL) user query at a computing device;
processing the NL user query using a native retrieval augmented generation (NatRAG) model to generate NatRAG output responsive to the NL user query, wherein the NatRAG model includes a generative portion and a retrieval portion, wherein processing the NL user query using the NatRAG model to generate NatRAG output comprises:
generating NatRAG input based on at least the NL user query;
processing the NatRAG input using the generative portion of the NatRAG model to generate one or more output tokens, in a sequence of output tokens, wherein the generative portion of the NatRAG model includes at least a set of decoder layers;
determining whether the one or more output tokens includes a need to retrieve (N-t-R) token, wherein the N-t-R token indicates the generative portion of the NatRAG model requires additional information;
processing one or more portions of the set of decoder layers using the retrieval portion of the NatRAG model to generate one or more retrieval tokens in a sequence of retrieval tokens;
appending the one or more retrieval tokens to the NatRAG input to generate updated NatRAG input;
processing the updated NatRAG input using the NatRAG model to generate NatRAG output responsive to the NL user query; and
causing the computing device to perform one or more actions based on the NatRAG output.

2. The method of claim 1, wherein processing the updated NatRAG input using the NatRAG model to generate NatRAG output responsive to the NL user query comprises:
processing the updated NatRAG input using the generative portion of the NatRAG model to generate one or more additional output tokens, in the sequence of output tokens, wherein processing the updated NatRAG input using the generative portion of the NatRAG model includes updating at least the set of decoder layers based on the updated NatRAG input; determining whether the one or more additional output tokens includes an additional instance of the N-t-R token;
processing one or more portions of the updated set of decoder layers using the retrieval portion of the NatRAG model to generate one or more additional retrieval tokens in an additional sequence of retrieval tokens;
appending the one or more additional retrieval tokens to the updated NatRAG input to generate further NatRAG input; and
processing the further NatRAG input using the NatRAG model to generate NatRAG output responsive to the NL user query.

3. The method of claim 1, wherein the generative portion of the NatRAG model is a pre-trained decoder only model.

4. The method of claim 3, wherein the generative portion of the NatRAG model is generated based on setting frozen weights, of a set of attention layers corresponding to the set of decoder layers, based on weights of a set of attention layers of the pre-trained decoder only model.

5. The method of claim 4, wherein the retrieval portion of the NatRAG model includes one or more trainable layer weights, wherein the one or more trainable layer weights are learnable parameters indicating the strength of connection between the set of attention layers of the generative portion of the NatRAG model.

6. The method of claim 1, wherein appending the one or more retrieval tokens to the NatRAG input to generate the updated NatRAG input does not include reencoding previously encoded output.

7. The method of claim 1, wherein the updated NatRAG input is generated based on appending the one or more retrieval tokens to an instance of the NatRAG input stored in memory of the computing device.

8. A system comprising:
memory storing instructions;
one or more processors configured to execute the instructions to:
receive a natural language (NL) user query at a computing device;
process the NL user query using a native retrieval augmented generation (NatRAG) model to generate NatRAG output responsive to the NL user query, wherein the NatRAG model includes a generative portion and a retrieval portion, wherein processing the NL user query using the NatRAG model to generate NatRAG output comprises:
generate NatRAG input based on at least the NL user query;
process the NatRAG input using the generative portion of the NatRAG model to generate one or more output tokens, in a sequence of output tokens, wherein the generative portion of the NatRAG model includes at least a set of decoder layers;
determine whether the one or more output tokens includes a need to retrieve (N-t-R) token, wherein the N-t-R token indicates the generative portion of the NatRAG model requires additional information;
process one or more portions of the set of decoder layers using the retrieval portion of the NatRAG model to generate one or more retrieval tokens in a sequence of retrieval tokens;
append the one or more retrieval tokens to the NatRAG input to generate updated NatRAG input;
process the updated NatRAG input using the NatRAG model to generate NatRAG output responsive to the NL user query; and
causing the computing device to perform one or more actions based on the NatRAG output.

9. The system of claim 8, wherein the instructions to process the updated NatRAG input using the NatRAG model to generate NatRAG output responsive to the NL user query include:
process the updated NatRAG input using the generative portion of the NatRAG model to generate one or more additional output tokens, in the sequence of output tokens, wherein processing the updated NatRAG input using the generative portion of the NatRAG model includes updating at least the set of decoder layers based on the updated NatRAG input;
determine whether the one or more additional output tokens includes an additional instance of the N-t-R token;
process one or more portions of the updated set of decoder layers using the retrieval portion of the NatRAG model to generate one or more additional retrieval tokens in an additional sequence of retrieval tokens;
append the one or more additional retrieval tokens to the updated NatRAG input to generate further NatRAG input; and
process the further NatRAG input using the NatRAG model to generate NatRAG output responsive to the NL user query.

10. The system of claim 8, wherein the generative portion of the NatRAG model is a pre-trained decoder only model.

11. The system of claim 10, wherein the generative portion of the NatRAG model is generated based on setting frozen weights, of a set of attention layers corresponding to the set of decoder layers, based on weights of a set of attention layers of the pre-trained decoder only model.

12. The system of claim 11, wherein the retrieval portion of the NatRAG model includes one or more trainable layer weights, wherein the one or more trainable layer weights are learnable parameters indicating the strength of connection between the set of attention layers of the generative portion of the NatRAG model.

13. The system of claim 8, wherein appending the one or more retrieval tokens to the NatRAG input to generate the updated NatRAG input does not include reencoding previously encoded output.

14. The system of claim 8, wherein the updated NatRAG input is generated based on appending the one or more retrieval tokens to an instance of the NatRAG input stored in memory of the computing device.

15. A non-transitory computer-readable storage medium storing instructions that, when executed by one or more processors of a system, cause the system to:
receive a natural language (NL) user query at a computing device;
process the NL user query using a native retrieval augmented generation (NatRAG) model to generate NatRAG output responsive to the NL user query, wherein the NatRAG model includes a generative portion and a retrieval portion, wherein processing the NL user query using the NatRAG model to generate NatRAG output comprises:
generate NatRAG input based on at least the NL user query;
process the NatRAG input using the generative portion of the NatRAG model to generate one or more output tokens, in a sequence of output tokens, wherein the generative portion of the NatRAG model includes at least a set of decoder layers;
determine whether the one or more output tokens includes a need to retrieve (N-t-R) token, wherein the N-t-R token indicates the generative portion of the NatRAG model requires additional information;
process one or more portions of the set of decoder layers using the retrieval portion of the NatRAG model to generate one or more retrieval tokens in a sequence of retrieval tokens;
append the one or more retrieval tokens to the NatRAG input to generate updated NatRAG input;
process the updated NatRAG input using the NatRAG model to generate NatRAG output responsive to the NL user query; and
causing the computing device to perform one or more actions based on the NatRAG output.

16. The non-transitory computer-readable storage medium of claim 15, wherein the instructions to process the updated NatRAG input using the NatRAG model to generate NatRAG output responsive to the NL user query include:
process the updated NatRAG input using the generative portion of the NatRAG model to generate one or more additional output tokens, in the sequence of output tokens, wherein processing the updated NatRAG input using the generative portion of the NatRAG model includes updating at least the set of decoder layers based on the updated NatRAG input;
determine whether the one or more additional output tokens includes an additional instance of the N-t-R token;
process one or more portions of the updated set of decoder layers using the retrieval portion of the NatRAG model to generate one or more additional retrieval tokens in an additional sequence of retrieval tokens;
append the one or more additional retrieval tokens to the updated NatRAG input to generate further NatRAG input; and
process the further NatRAG input using the NatRAG model to generate NatRAG output responsive to the NL user query.

17. The non-transitory computer-readable storage medium of claim 15, wherein the generative portion of the NatRAG model is a pre-trained decoder only model.

18. The non-transitory computer-readable storage medium of claim 17, wherein the generative portion of the NatRAG model is generated based on setting frozen weights, of a set of attention layers corresponding to the set of decoder layers, based on weights of a set of attention layers of the pre-trained decoder only model.

19. The non-transitory computer-readable storage medium of claim 18, wherein the retrieval portion of the NatRAG model includes one or more trainable layer weights, wherein the one or more trainable layer weights are learnable parameters indicating the strength of connection between the set of attention layers of the generative portion of the NatRAG model.

20. The non-transitory computer-readable storage medium of claim 15, wherein appending the one or more retrieval tokens to the NatRAG input to generate the updated NatRAG input does not include reencoding previously encoded output.
